(19) United States
(12) Patent Application Publication
(10) Pub. No.: US 2011/0099024 A1
(43) Pub. Date: Apr. 28, 2011

(54) HEALTHCARE MANAGEMENT SYSTEM

(76) Inventors: Christine Lee, Rocklin, CA (US); Grover Lee, Rocklin, CA (US)

(21) Appl. No.: 12/607,935

(22) Filed: Oct. 28, 2009

(51) Int. Cl. G06Q 50/00; G06F 17/30

(52) U.S. Cl. 705/2; 705/3

(57) ABSTRACT

The invention provides a computer useable medium encoded with a computer program for maintaining an electronic healthcare database, the medium comprising: a) a computer database for maintaining personal and medical records of a patient; b) means for remotely accessing said database to at least one provider of medical care for the patient; c) records of personal and medical information entered into said database by the provider; and d) an algorithm program for relating a diagnosed medical condition of the patient and at least one medical care action relating to the patient.

### REFERENCE TO RELATED APPLICATION

This application claims the benefit of U.S. Provisional Patent Application No. 61/109,429, filed Oct. 29, 2008, the complete disclosure of which is incorporated herein, in the entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

The present invention generally relates to healthcare management systems and methods, and more particularly, web-based electronic systems for supporting online medical records and treatment plans/options.

2. Description of Related Art

Hospitals and other medical service institutions retain records of patient information, including doctors' notes, treatment history, and so forth. To this end, hospitals use databases dedicated to maintaining and managing electronic medical documents and other patient information. Such databases retain data relating to all patients, including current patients and non-current patients, and include all medical information collected for each current and non-current patient. Thus, such databases can be quite large.

Hospital information system (“HIS”) databases are designed to handle large quantities of data and have limited, rigid, protocols for storing and retrieving information that can be difficult and/or time-consuming to learn. Unfortunately, conventional HIS systems are not adapted for convenient, everyday use by doctors or other caregivers. For example, to submit a note to be placed in a patient's record, a caregiver may need to navigate a complex user interface that requires an understanding of the HIS protocol. Some caregivers avoid using such systems because of their complexity.

The current HIS systems do not integrate tools for the healthcare professionals to communicate electronically with the patients. The current HIS systems do not provide tools to identify at-risk patients so that the healthcare professionals can intervene in a course of treatment or modify a course of treatment to optimize the patient's success and improving overall health.

United States Application No. 20070124178, published May 31, 2007, provides a method and device for maintaining and providing access to electronic clinical records. In this method a database is remotely accessible by one or more care givers and has software-based programming associated therewith. The database is populated with patients' clinical records and is remotely accessible to electronically retrieve at least a portion of the patient's clinical records. Clinical records are downloaded and displayed for viewing by the caregiver. Advertisements can also be displayed for viewing by the caregiver upon accessing the database.

United States Patent Application No. 20080300922, published Dec. 4, 2008, teaches an electronic medical documentation system for electronic medical documentation. The system receives a patient identifier and patient healthcare information from a user, associates the patient healthcare information with the patient identifier, and stores the patient healthcare information in an intermediate database.

United States Patent Application 20080288540, published Nov. 20, 2008, teaches a method of access to personal and medical information, for use by emergency personal in need of access to medical records.

United States Patent Application 20030036683, published Feb. 20, 2003, discloses a system and computer program product for internet-enabled, patient monitoring, that are useful in remotely modifying medical protocols by subgroups that are defined by specific database characteristics.

None of the prior approaches have been able to provide an interactive medical records system that is comprehensive, real-time and actively prompts all of the providers in the chain with relevant information of benefit to the patient.

Accordingly, there is a need for an improved system managing confidential patient information that does not suffer from the limitations of the prior art.

### SUMMARY OF THE INVENTION

The present provides a secure, web-based electronic healthcare management systems and methods (the “HMS”) for supporting online medical records and treatment plans/options with tools to identify at-risk patients. The novel further allows patients, healthcare providers and other individuals and entities to communicate electronically to securely and efficiently transfer information.

This invention more particularly provides both a database warehouse management system and a computer useable medium encoded with a computer program for maintaining an electronic healthcare database accessible through the web.

The system generally comprises: a) a computer database for maintaining personal and medical records of a patient; b) means for remotely accessing said database to at least one provider of medical care for said patient; c) records of personal and medical information entered into said database by said provider or electronically downloaded; d) an algorithm program for artificial intelligence relating a diagnosed medical condition of said patient and at least one medical care action relating to said patient; e) means for communication between medical providers simultaneously or at different times; f) means of web cam communication; g) means of identifying laboratory values or test results not in normal range; h) means of scheduling appointments; i) means of scanning documents; j) means of billing; and k) printable patient information.

In one embodiment, the algorithm program identifies at-risk patients having deficiencies in their care.

In another embodiment, the system further provides: e) a program for communicating a notification of risk to the provider.

In a further embodiment, the notification identifies corrective measures that should be considered for the patient.

In a still further embodiment, the corrective measure is directed to a change of medication for the patient or a procedure test needed.

In another embodiment, the notification further comprises information about the medication, gaps days in medication, compliance, lack of medication, poly-pharmacy, prescriber and duplication.

In a different embodiment, the corrective measure is directed to a treatment option for the patient.

In another embodiment, the corrective measure shows hospitalization and procedures for the patient.

In a still different embodiment, the database is accessible through a secured and password-protected web-based communication portal.

In a still further aspect, the medical information comprises medical care relating to the patient.

In a further such aspect of the invention, in step c), the medical information comprises prescriptions prescribed, laboratory and procedure test for the patient.

In a different embodiment, the computer database is encrypted.

In a different embodiment the algorithm is based on historic relationships associated with medical care and the diagnosed medical condition.

In another embodiment the algorithm is based on established treatment regimens for the diagnosed medical condition.

In a different embodiment the notification of risk provides the provider with a risk analysis evaluation for the patient.

In a different embodiment the notification of patient treatment deficiencies is provided to the provider.

In another embodiment, patients who have gone to the emergency room and the procedures provided in emergency room are identified.

The medium of claim 37 where patients with emerging risk are identified by the notification.

In one embodiment the database integrates the patient's medical profile and care manager's clinical visits with lab results into the database.

In another embodiment, the medical profile includes medical (medical diagnosis and procedures), pharmacological (prescription and over the counter medications), laboratory care relating to the patient, documents from physician or laboratory results.

In a still further embodiment the provider is selected from the group consisting of physician, physician assistant, pharmacist, nurse practitioner, nurse and case manager.

In another aspect, the database comprises scanned medical documents relating to the patient.

In a different embodiment the system allows access to the database for medically related administrative functions at a different level of access then a physician or care manager.

In a still different embodiment, the medically related administrative functions allows care to be instantaneously documented.

In another embodiment the medically related administrative functions allows services to be instantaneously billed.

In another aspect the system has a reminder to follow up on an area of concern for the care manager.

In another embodiment the system provides artificial intelligence that flags information of laboratory results out of range, potential risk, and procedure test not in control or not done.

In another embodiment communication between physicians or care managers can be simultaneously.

In another embodiment access to printable medical patient information is provided.

In another embodiment Web Cam communication is accessible.

In another embodiment search for a particular medical procedure, physician or medication is accessible by date or name.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 shows an overview flow diagram of the HMS system.

FIG. 2 is a flow diagram depicting information gathering during a patient visit and integrating it with the patient medical records, disease states, medication and treatment protocols and options to formulate a treatment plan and follow-up for the patient.

FIG. 3 illustrates a case overview using the HMS systems and methods.

FIG. 4 illustrates the logical architecture for the HMS systems and methods.

FIG. 5 illustrates the logical architecture for the HMS systems and methods to ensure security of the information inputted and outputted from the databases and networks.

FIG. 6 illustrates the process architecture for the HMS systems and methods.

FIG. 7 shows a schematic diagram of an exemplary system of various databases and software modules.

FIG. 8 illustrates an integrated HMS using the tools claimed by this invention.

FIG. 9 show exemplary pharmacy data formats for use in the HMS systems and methods.

FIG. 10 shows exemplary medical data formats for use in the HMS systems and methods.

FIG. 11 is an example illustrating the basic user-to-user model.

### DETAILED DESCRIPTION OF THE INVENTION

The following detailed description of embodiments of the present invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Referring to the figures, the block system diagram and process flow diagram represent mere embodiments of the invention and are not intended to limit the scope of the invention as described herein. For example, the steps recited in each of the figures may be executed in any order and are not limited to the order presented.

The term “user” refers to any person, having a secure authorization code, accessing and/or utilizing the HMS.

The term “user device” is meant to refer to any electronic device or method of electronic communication over the Internet or wireless network, such as notebook computers, cellular telephones, personal data assistants (PDAs), smart-phones and other similar communication devices having Internet access.

The term “patient” is a person whose electronic medical document information is used regularly and/or frequently by a caregiver and may include, for example, patients admitted to a hospital and/or patients currently undergoing treatment. This includes a patient whose electronic medical document information is not used regularly or frequently by a caregiver and may include, for example, patients released from a hospital and/or patients no longer receiving treatment.

The term “tools” refers to algorithms and computer software implemented into the HMS to actively target and identify patient risk factors such as disease potential, active disease, current therapies, new therapies, etc. to optimize a patient's course of treatment for improved 6 wellbeing.

The term “electronic medical document” is a medical record or other document unit containing patient-specific healthcare information.

The term “network” includes any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Tatty, HTTP, The Definitive Guide (2002), the contents of which are hereby incorporated by reference.

The various HMS components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

The present invention can be implemented in hardware, software, firmware, or a combination thereof. In a preferred embodiment, however, the invention is implemented with a computer program. The computer program and equipment described herein are merely examples of a program and equipment that may be used to implement the invention and may be replaced with other software and computer equipment without departing from the scope of the present invention.

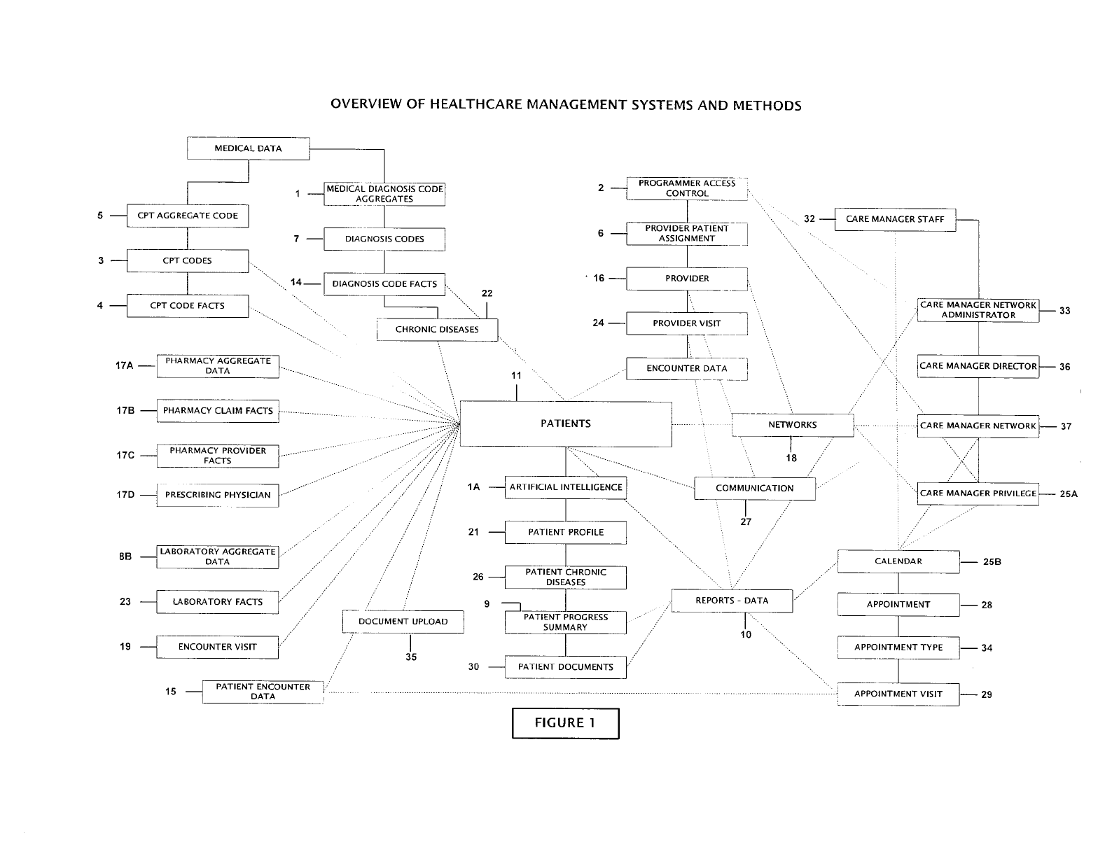

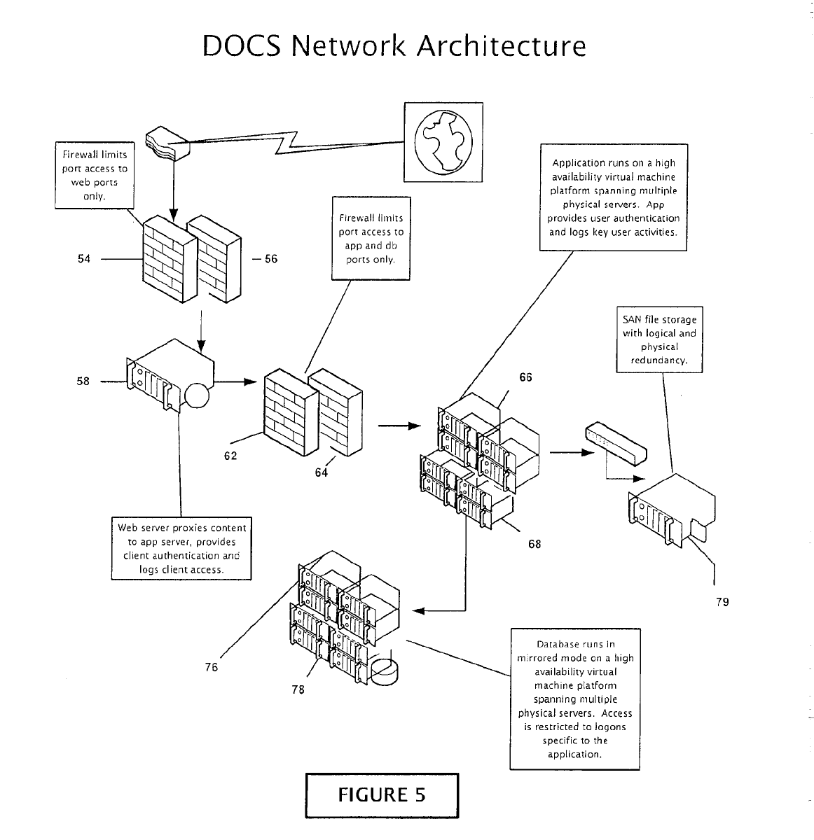

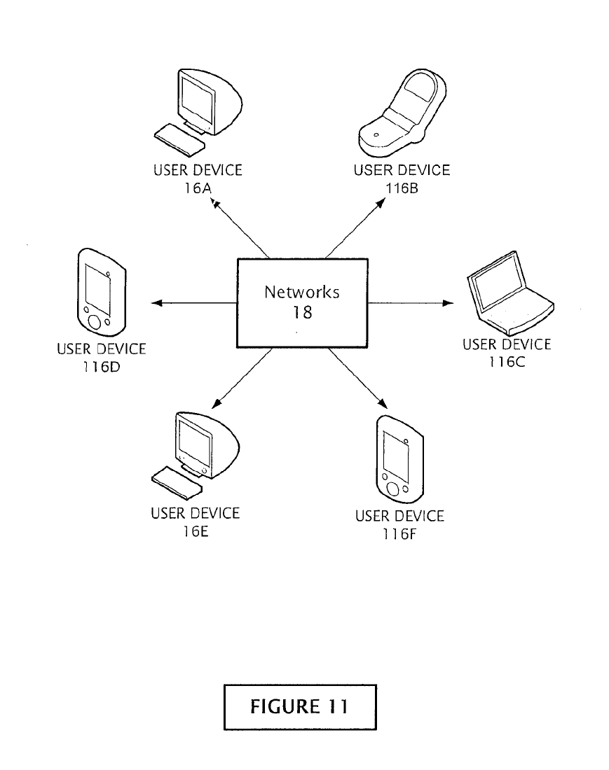

The computer program of the present invention is stored in or on a computer-usable medium, such as a computer-readable medium, residing on or accessible by a host computer for instructing the host computer to implement the method of the present invention as described herein. The host computer may be one or more server computers 58, 60 (FIG. 5) or a network client computer 18 (FIGS. 1 and 11) or the hand-held computing device. The computer program preferably comprises an ordered listing of executable instructions for implementing logical functions in the host computer and other computing devices coupled with the host computer. The computer program can be embodied in any computer-usable medium for use by or in connection with an instruction execution system, apparatus, or device, such as a computer-based system, processor-containing system, or other system that can fetch the instructions from the instruction execution system, apparatus, or device, and execute the instructions.

The executable instructions comprising the computer program of the present invention will hereinafter be referred to simply as “the program”, “the computer program” or “the HMS”. It will be understood by those skilled in the art that the program may comprise a single list of executable instructions or two or more separate lists, and may be stored on a single computer-usable medium or multiple distinct media. The program will also be described as comprising various “code segments,” which may include one or more lists, or portions of lists, of executable instructions. Code segments may include overlapping lists of executable instructions, that is, a first code segment may include instruction lists A and B, and a second code segment may include instruction lists B and C.

As used herein, a “computer-usable medium” may be a computer readable medium or any means that can contain, store, communicate, propagate or transport the program for use by or in connection with the instruction execution system, apparatus, or device. The computer-usable medium can be, for example, but is not limited to, an electronic, magnetic, optical, electro-magnetic, infrared, or semi-conductor system, apparatus, device, or propagation 8 medium. More specific, although not inclusive, examples of computer-usable media would include the following: an electrical connection having one or more wires, a portable computer diskette or drive including external hard drives and flash drives, a random access memory (RAM), a read-only memory (ROM), an erasable, programmable, read-only memory (EPROM or Flash memory), an optical fiber, and a portable compact disk read-only memory (CDROM). The computer-usable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The present invention relates to a system and method of electronic medical documentation and patient support tools. FIG. 1 illustrates the various access points for data input and output 1-37. Management of the electronic medical document database may be governed by laws such as the Health Insurance Portability and Accountability Act of 1996 (“HIPAA”). The electronic medical document database 30 may be accessible via a protocol such as Health Level Seven or other messaging standard that enables disparate healthcare applications to exchange patients' personal healthcare information, including clinical and administrative data.

FIG. 1 shows the powerful ability to assimilate all the various types of data that is associated with a patient's medical history and current medical assessment which is obtained from various sources. The patient is shown at the center of the diagram because all information gathered is drilled down to be patient-specific. The medical data 1, 7, 14, and 22 comprise diagnosis codes representing disease states with or without complications, the diagnosis code facts for description, and chronic disease states. The pharmacy component 17A, 17B,17C, and 17D contains information about what medications are dispensed, what pharmacy dispensed the medication, which physician prescribed the medication, how many pills were dispensed and the days supply. This provides useful information that can be used in determining medication compliance, conflicting medications, medication abuse, and lack of medication, poly-pharmacy or wrong medications.

The laboratory data 8 and 23 give the test names and results. Laboratory data provides bench mark results for baseline health analysis, treatment success or failure and confirms diagnosis.

Encounter data 19 and 15 provide current assessment of the patient visits with care managers, such as blood pressure, feet examine, over-the-counter medications, and clinical information of overall mental and physical health related issues. Care managers may include physician, pharmacist, nurse practitioners, and nurses, as well as agents of these professionals. Care managers 32, 33, 36, 37, and 25 are divided into networks in which a director is responsible for care managers to provide care to the patient.

The care manager has access to the patient's records through a documentation portal that provides patient-specific information, as discussed in FIG. 1 and action plan through reports and data 10 that have been provided by the artificial intelligence 1A. Communication 27 is real time communication in which one or several care managers can communicate health findings or concerns between each other anywhere in the world where access to the internet is available. The access control 2 is only given by the programmer as well as the level of access whether administrative or clinical. The calendar 25B provides scheduling, number of appointments per care manager, and missed appointment through the web.

The data stored in the HMS databases, such as the medical records database, 30, may be compartmentalized and downloaded for efficient access through remote user modules such as handheld computers or PDA's where computer networks are not available. This is helpful in situations where the caregiver, 16, 31, is visiting a remote location beyond range of a wireless communications network, 18. In such situations, the caregiver, 16, 31, is able to view patient data, 15, 19, 22, 26, 30 stored on the handheld computing device. When communications are restored between the client modules and the intermediate database 30, the information obtained can now be input into the computer system.

The program is further operable to automatically import external information 9 (e.g., CPT codes and information, 3, 4, 5; insurance information, 8; pharmacy information, 17 A, B, C, D, 23, 40, 41) into an information template. Certain medical information relating to each patient may be gathered each day, such as weight, blood pressure, temperature, and so forth. The program may store this information in the appropriate databases or otherwise access the information to import it into a particular template upon request by the user such that the template is presented to the user with the external information. Thus, information submitted by the user may be automatically supplemented by contemporaneous external information, saving the user the time required to manually submit the information.

The networks 18 enables communications between the electronic medical document database 21, 26, 9, 30 and the various users such as, providers 16, care managers 31, and other persons or entities authorized with access to the HMS. The electronic medical document database 30 is a database operable to store a plurality of electronic medical documents containing particular patient's medical information, medical documents and notes, historical and current clinical encounter data 49, quality and risk measures 45, pharmacy data 17, and over the counter medications. The database 30 may be comprehensive in that it may store all patient information from both current patients and non-current patients.

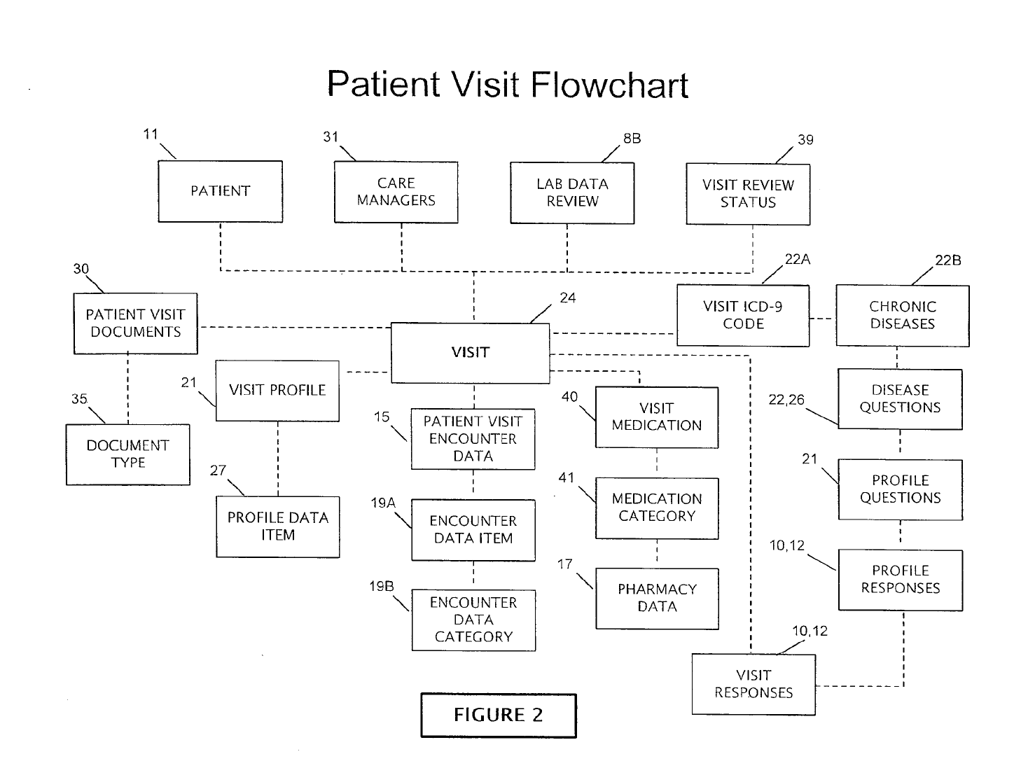

FIG. 2 illustrates the systems and methods for care managers 31 to schedule a patient visit 15, 19, 21, 24, 27, review patient records 30, 35, monitor a patient's health status 21, 22, 39, and authorize treatment options 10, 12, including medications 40, 41. The patient visit flowchart depicts aspects of how a care manager reviews the patient at a visit. There are 3 major areas of review; clinical encounter data and answers to questions 21, 22, 26, 15, 19, 10, 12, medical and pharmacy data that is comprised of 22, 41, 40,41, and profile data 27 in which the artificial intelligence has analyzed deficiencies, risk and treatment failure and provides actional items.

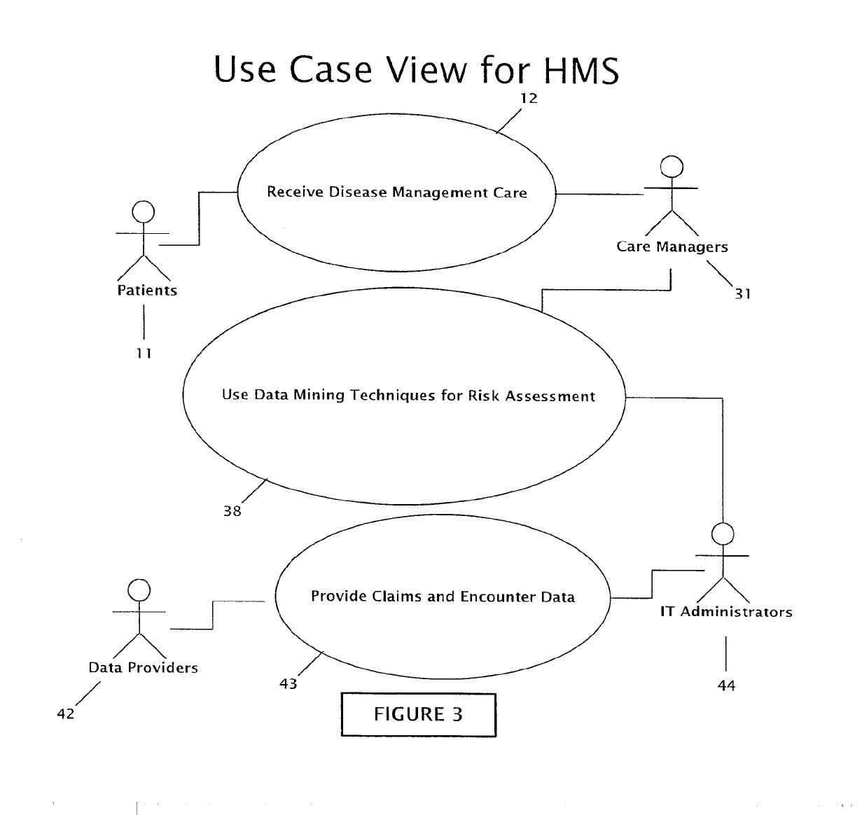

FIG. 3 illustrates a case overview for a particular patient 11 by a care manager 31. The patient 11 receives disease management care 12 from the care managers 31 utilizing the HMS systems which provides data mining techniques for risk assessment 38. The data mining techniques for risk assessment 38 includes each of the components 1-37 identified in FIG. 1. Data providers 42 enter information into the HMS databases to provide claims and encounter data information 43. The claims and encounter information includes the components 3, 4, 5, 9, 15, 19, 22, 27, identified in FIG. 1. The IT Administrators 44 manage the networks to provide maintenance, upgrades, optimization and security monitoring.

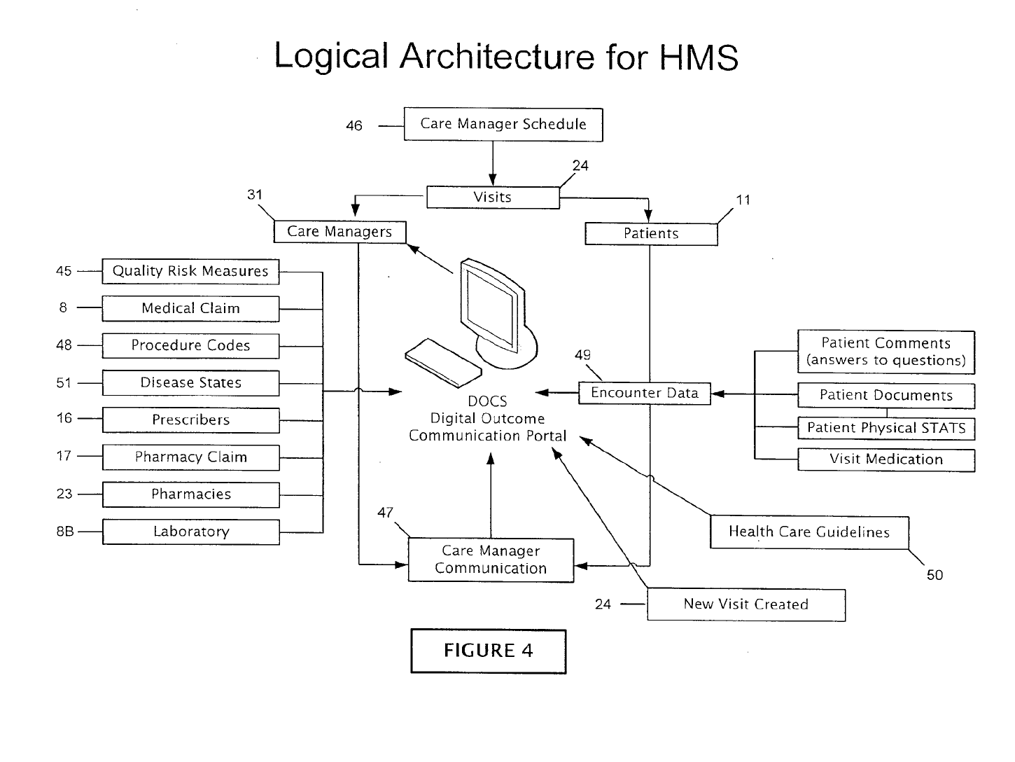

FIG. 4 illustrates the general flow of information and integration of the various HMS components to generate quality risk measures, 45, healthcare guidelines for disease states, gender and age, 50, identify procedures that have been done and what procedures need to be done, 48, medications prescribed, compliance and medication gaps in therapy, 8B, and encounter data, 49, to optimize the patients', 11, healthcare treatments. In this information integration schematic, the care managers, 31, can communicate through the HMS 47 with the 10 necessary healthcare professionals such a physicians, nurse practitioners and pharmacist 17 to prescribe medications, through specific pharmacies, 23.

FIG. 5 illustrates the security components and data accuracy components of the HMS, demonstrating how the HMS's′ architecture follows the C-I-A (Confidentiality-Integrity-Availability) principle of security. There are stringent security requirements enforced by several firewalls and intrusion detection systems. The security infrastructure for the HMS affords authorized care managers to access the HMS easily while preventing unauthorized access and auditing each and every data access.

The primary internet firewall 54 may be of any of the known systems designed to prevent unauthorized access to or from a private network. Firewalls can be implemented in both hardware and software, or a combination of both. Firewalls are frequently used to prevent unauthorized Internet users from accessing private networks connected to the Internet, especially intranets. All messages entering or leaving the intranet pass through the firewall, which examines each message and blocks those that do not meet the specified security criteria.

The Internet Firewall 54 in the HMS allows only https (Hyper Text Transport Protocol over SSL) traffic to pass through to the HMS web server from IP addresses that are allowed to access the HMS.

The redundant internet firewall 56 is a standby firewall that monitors the primary internet firewall 54 for availability. In the event of failure of the primary internet firewall 54, the standby internet firewall 56 assumes the responsibility of primary internet firewall 54 with minimal interruption to the availability of the HMS.

The primary web server 58 delivers (serves up) Web pages. Each Web server has an IP address and possibly a domain name. For example, if you enter the URL https://docs.ahcrx.com/docs in your browser, this sends a request to the server whose domain name is docs.ahcrx.com. The server then fetches the page named index.html and sends it to your browser.

The HMS preferably utilizes a version of Apache web server that is always kept up-to-date. The Apache webs server as proxy to the HMS application server.

The primary application firewall 62 protects the application server by restricting access to the application server 58.

The standby application firewall 64 monitors the primary application firewall 62 for availability. In the event of failure of the primary application firewall 62, the standby application firewall 64 assumes the responsibility of primary application firewall 62 with minimal interruption to the availability of the HMS.

The HMS may be deployed on a Java application, for example one distributed by JBoss, a subsidiary of Red Hat Inc. The primary application server 66 provides a container for services like database connection, application security and application deployment over the Web.

The standby application server 68, with the High Availability (HA) system, monitors the status of the primary application server 66 for availability and in the event of physician server failure of the primary application server 66; affected applications are automatically restarted on other production servers with spare capacity. In the case of operating system failure, our HA system restarts the affected physical server. This provides the ability to deliver the level of availability required for all of the important applications.

The HMS may utilize as the primary database server 76 an enterprise Relational Database Management System for storing all the data pertaining to the HMS. All data is mirrored and backed up off site.

The standby database server 78 monitors the status of the primary database server 76 and assumes the responsibility of the primary responsibility if the Primary Database Server fails minimizing unavailability of the HMS.

Hard Drive Physical Storage (79) may be provided by San file storage, as the hard drive with logical and physical redundancy storage.

Every database transaction in the HMS is crucial and cannot be lost. It is possible that a server may fail as a result of hardware or software failure. The HMS is implemented on a pair of databases for database replication 80. There is a primary database and secondary database. All transactions from the primary database are copied to the secondary or standby database in real-time mode. This mode of replication guarantees nearly 100% up time of the application and insures 0 data loss.

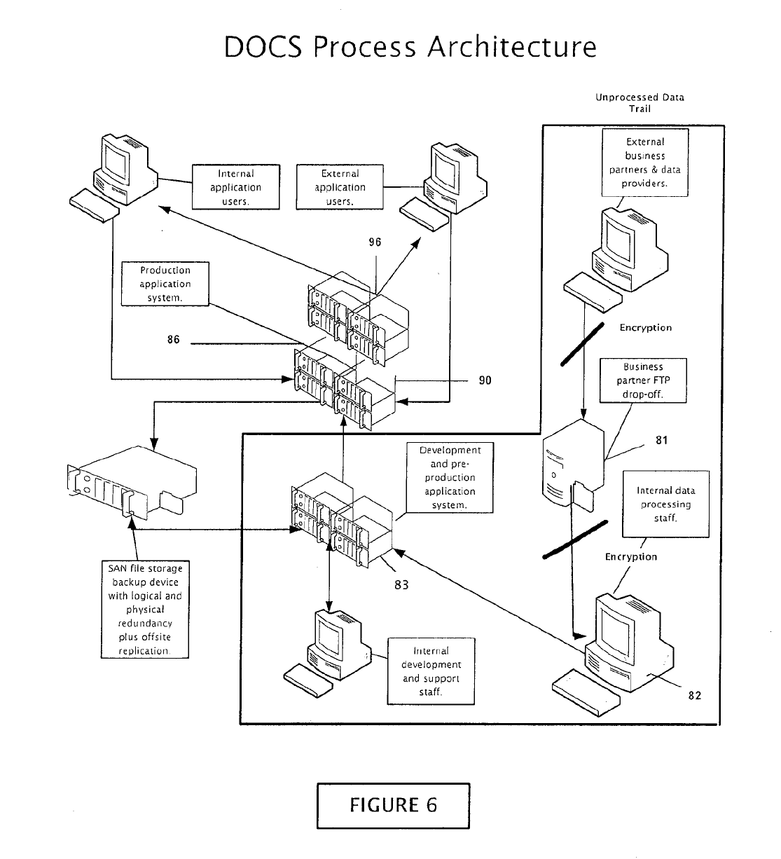

Turning now to FIG. 6, the drawing describes the HMS encryption, which is employed at two levels. The entire data exchange between the client machine and the HMS server is encrypted using SSL technology with 256 bit key. All private information within the database are encrypted using 3DES and MD5 algorithms.

Secure FTP refers to the practice of tunneling a normal FTP session over an SSH connection, providing an FTP site for data delivery 81. Unlike standard FTP, it encrypts both commands and data, preventing passwords and sensitive information from being transmitted in the clear over the network SSH (Secure Shell) is a protocol for creating a secure connection between two computers. American Health Care employs the latest Secure FTP (SFTP) servers for transferring files using either a local client application or a web site portal.

The HMS helps the care managers to manage of health of the members with the help of two sets of information; historical claims and information gathered during the visit of the member. The HMS employs a data load process 82 with sophisticated data cleaning and loading processes to input medical and pharmacy claim information for each member.

The development and pre-production application system 83, and its mirrored copy, are housed in a separate physical location from the production application system to ensure program security and the integrity of the production server.

The first login pop up to the user is provided by the Apache web server. Web server replication 86 is yet another example of the usability feature of the HMS. In the event of failure of the primary web server, the user authentication information remains available on the primary server.

The HMS provides high availability by using a combination of hardware and software clustering 90. Hardware clustering makes two or more computers appear as one computing node. Hardware Clustering makes more computer power available for the application. The HMS is designed for hardware clustering of the database.

The HMS employs software clustering for the web server and the application server. The web server and the application server are configured identically for fail over scenario. In the case of the failure of the primary web server, the secondary web server takes over the load in a manner that keeps the switchover transparent to the users. There is similar software clustering in place for the application server.

The High Availability (HA) system monitors the status of the Primary Application Server for availability and in the event of physical server failure of the Primary Application Server; affected applications are automatically restarted on other production servers with spare capacity. In the case of operating system failure, our HA system restarts the affected physical server. This provides the ability to deliver the level of availability required for all of the important applications.

The HMS employs rigorous user access control mechanism 96 to ensure that only authorized users have access to the data.

There are several aspects to the user access control mechanism 96. Following is the list.

1. Only users from a white list of IP addresses are allowed to access the HMS web site.

2. When a user accesses the HMS web site, they are presented with a pop up screen that demands authentication information. This is controlled by the web server.

3. Once, the user has been authenticated by the web server, she has to again enter her login and password at the home page of the HMS.

4. The HMS controls which groups the user has access to, the subset of members within the group the user can manage and the types of data this user can manipulate.

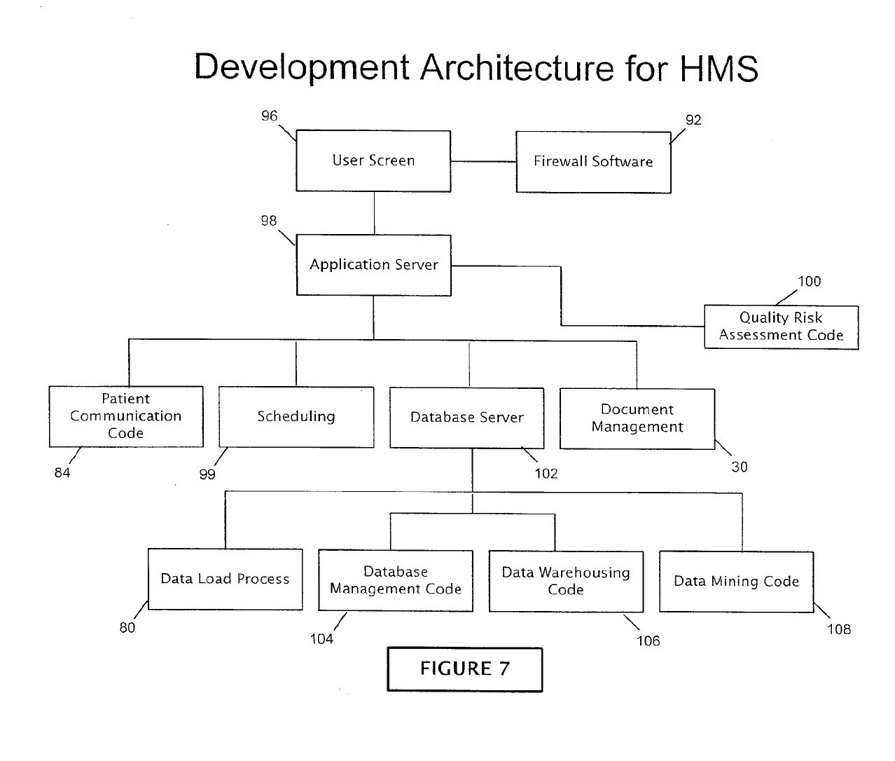

A schematic diagram of an exemplary system of various databases and software modules is illustrated in FIG. 7. An electronic medical document database 30 (FIG. 1), 102, is in communication with an application server 98. A plurality of modules 96, 84, 99, 30, 100, 80, 104, 106, 108 are in communication with the application server 98. The program may be embodied in the application server 98.

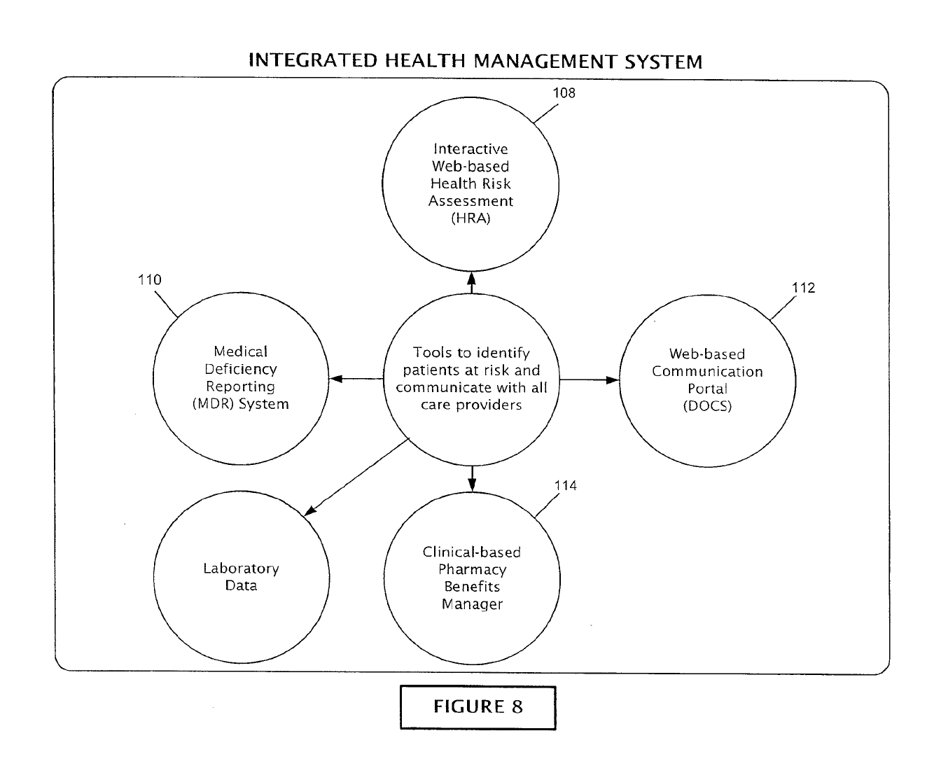

FIG. 8 illustrates an embodiment of the HMS 38. The utilities, tools, modules, or any other HMS 38 component, may interact with any number of additional computing systems and databases in order to facilitate, for example, administration, matching, security, appointment scheduling, electronic prescribing, registration, advertising, and etc. Computing systems and databases residing outside of HMS 38 may be administered by any other third party entity directly or indirectly involved in facilitating the disclosed system and having secured authorization by the HMS and IT administrators. Such third party entities may include governmental organizations, financial institutions, non-profit organizations, small businesses, corporations, and the like.

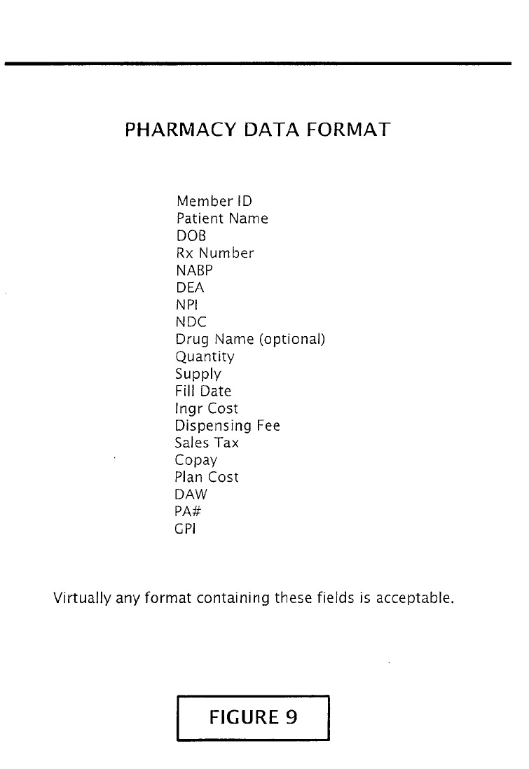

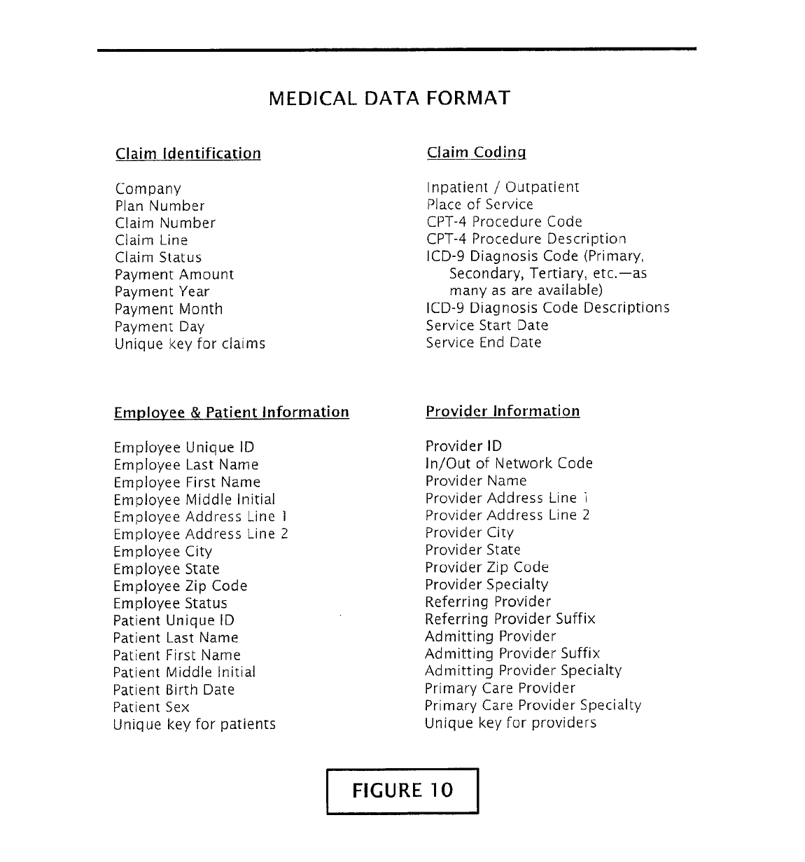

The program is further operable to provide-one or more templates for the submission of information. FIGS. 9 and 10 illustrate exemplary pharmacy and medical data formats used to input information into the various databases comprising the HMS. The program may present a list, for example, of different types of templates and enable the user to select a template from the list of templates. A template may include certain preformatted information with fields for the user to populate with information. The program may further enable users to create and/or modify templates, may provide fill information with which to populate templates, and may allow users to customize the fill information.

The inputted and outputted data may include information that is regularly 11 recorded either by persons working with a patient or automatically by monitoring equipment. By way of example, the providers, 16, or care managers, 31, may input patient encounter data, 15, 19, such as temperature, pulse, weight, and so forth, or may include information about medication administered to the patient, 40, 41, or other treatment information, 22, 26.

By way of further example, an attending physician, 16, may create a note relating to a patient, 11, and store the note, 15, 19, in the patient records database 30. The attending physician, 16, or other caregiver, 31, such as a consulting physician, 16, or medical student, 16, may view the note at a later time and add information to the note. When the note is complete, the attending physician, 16, may submit the note to the electronic medical document database 30 and sign the note.

FIG. 11 shows several user devices 116(A)-116(F) connected over the HMS networks 18. The method of the present invention is especially well-suited for implementation on a computer or computer network as illustrated in FIG. 11. It will be appreciated that any or all of the databases and software modules discussed herein may be effectively implemented on various combinations of computing devices, or even on a single computing device.

The program is operable to identify particular data from the electronic medical document database 30. By way of example, the program may identify patients 11 on a list of patients as current patients, wherein the list is maintained by caregivers 16, 31. Alternatively, the program may identify patients 11 according to data in the electronic medical document database 30, such as a data field relating to each patient indicating a status 39 of the patient 11.

Although embodiments of the present invention have been described with reference to the attached drawings, it is noted that equivalents may be employed and substitutions made herein without departing from the scope of the subject matter recited in the claims.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A system for managing the administration of medical care, said method comprising the steps of:
a) establishing a computer database for maintaining personal and medical records of a patient;
b) providing means for remotely accessing said database to at least one provider of medical care for said patient;
c) allowing said provider to enter personal and medical information relating to said patient into said database;
d) applying artificial intelligence by at least one algorithm to said database relating a diagnosed medical condition of said patient and at least one medical care action relating to said patient;
e) identifying at-risk patients having deficiencies in their care; and
f) communicating a notification of risk to said provider.

2. The system of claim 1 wherein said database is accessible through a secured and password-protected web-based communication portal.

3. The system of claim 1 wherein in step c), said medical information comprises medical care relating to said patient.

4. The system of claim 1 wherein in step c), said medical information comprises information selected from the group consisting of prescriptions prescribed, test results and results of laboratory procedures for said patient.

5. The system of claim 1 wherein said computer database is encrypted.

6. The system of claim 1 wherein said algorithm is based on historic relationships associated with medical care and said diagnosed medical condition.

7. The system of claim 1 wherein said algorithm is based on established treatment guidelines for said diagnosed medical condition.

8. The system of claim 1 wherein said notification of risk provides said provider with a risk analysis evaluation for said patient.

9. The system of claim 8 wherein patients who have gone to the emergency room are identified by said notification along with the procedures provided in said emergency room.

10. The system of claim 1 further comprising a reminder to follow up on an area of concern for the care manager.

11. The system of claim 8 wherein patient with emerging risk are identified by said notification.

12. The system of claim 1 wherein said database integrates said patient's medical profile into said database.

13. The system of claim 11 wherein said medical profile includes medical, pharmacological, laboratory and procedural care relating to said patient.

14. The system of claim 1 further comprising;
g) identifying corrective measures that should be considered for said patient.

15. The system of claim 1 wherein said corrective measure includes a measure selected from the group consisting of a change to or addition of medication for said patient.

16. The system of claim 14 further comprising information about said medication, comprising at least one of information regarding what the medication is used for, gaps days in medication, gaps in compliance, lack of medication, poly-pharmacy, poly-prescriber, duplications and contraindications.

17. The system of claim 1 wherein said corrective measure is directed to a treatment option for said patient.

18. The system of claim 1 wherein said shows hospitalization and procedures for said patient.

19. The system of claim 1 wherein said provider is selected from the group consisting of physician, physician assistant, pharmacist, nurse practitioner, nurse and case manager.

20. The system of claim 1 wherein said database further comprises scanned medical documents relating to said patient.

21. The system of claim 1 further comprising access to said database for medically related administrative functions.

22. The system of claim 21 wherein said medically related administrative functions allow care to be instantaneously documented.

23. The system of claim 21 wherein said medically related administrative functions include such functions as allowing services to be instantaneously billed, visit appointments made or management directives issued for care managers.

24. The system of claim 1 further comprising means of identifying laboratory values or test results not in normal range.

25. A computer useable medium encoded with a computer program for maintaining an electronic healthcare database, said medium comprising:
a) a computer database for maintaining personal and medical records of a patient;
b) means for remotely accessing said database to at least one provider of medical care for said patient;
c) records of personal and medical information entered into said database by said provider; and
d) an algorithm program for relating a diagnosed medical condition of said patient and at least one medical care action relating to said patient.

26. The medium of claim 25 wherein said algorithm program identifies at-risk patients having deficiencies in their care.

27. The medium of claim 25 further comprising a program for communicating a notification of risk to said provider.

28. The medium of claim 26 wherein said notification identifies corrective measures that should be considered for said patient.

29. The medium of claim 27 wherein said corrective measure includes measures selected from the group consisting of a change to or addition of medication for said patient.

30. The medium of claim 28 wherein said notification further comprises information about said medication, comprising at least one of information regarding what the medication is used for, gaps days in medication, gaps in compliance, lack of medication, poly-pharmacy, poly-prescriber, duplications and contraindications.

31. The medium of claim 27 wherein said corrective measure is directed to a treatment option for said patient.

32. The medium of claim 27 wherein said corrective measure includes measures selected from the group consisting of hospitalization and procedures for said patient.

33. The medium of claim 25 wherein said database is accessible through a secured and password-protected web-based communication portal.

34. The medium of claim 25 wherein in step c), said medical information comprises medical care relating to said patient.

35. The medium of claim 25 wherein in step c), said medical information comprises prescriptions prescribed for said patient.

36. The medium of claim 25 wherein said computer database is encrypted.

37. The medium of claim 25 wherein said algorithm is based on historic relationships associated with medical care and said diagnosed medical condition.

38. The medium of claim 25 wherein said algorithm is based on established treatment regimens for said diagnosed medical condition.

39. The medium of claim 25 wherein said notification of risk provides said provider with a risk analysis evaluation for said patient.

40. The medium of claim 38 wherein patients with risk are identified by said notification.

41. The medium of claim 38 wherein patients with emerging risk are identified by said notification.

42. The medium of claim 38 wherein said database integrates said patient's entire medical profile into said database.

43. The medium of claim 41 wherein said medical profile includes medical, pharmacological, and laboratory care relating to said patient.

44. The medium of claim 42 wherein said provider is selected from the group consisting of physician, physician assistant, pharmacist, nurse practitioners, nurse and case manager.

45. The medium of claim 35 wherein said database further comprises scanned medical documents relating to said patient.

46. The medium of claim 25 wherein said database makes accessible printable information for a patient profile.

47. The medium of claim 25 further comprising access to said database for medically related administrative functions.

48. The medium of claim 25 wherein said medically related administrative functions allows care to be instantaneously documented.

49. The medium of claim 25 wherein said medically related administrative functions allows services to be instantaneously billed.

50. The medium of claim 25 further comprising means of identifying laboratory values or test results not in normal range.
